(19) United States
(12) Patent Application Publication
(10) Pub. No.: US 2009/0083050 A1
(43) Pub. Date: Mar. 26, 2009

(54) COMPILATION AND DISTRIBUTION OF DATA FOR AIRCRAFT FLEET MANAGEMENT

(76) Inventors: Joseph T. Eltman, Waterbury, CT (US); Edward T. Kell, Wallingford, CT (US); Michael H. DeHart, Milford, CT (US)

Correspondence Address: CARLSON, GASKEY & OLDS, P.C., 400 WEST MAPLE ROAD, SUITE 350, BIRMINGHAM, MI, 48009, US

(21) Appl. No.: 11/860,575

(22) Filed: Sep. 25, 2007

(51) Int. Cl. G06Q 10/00

(52) U.S. Cl. 705/1

(57) ABSTRACT

A fleet management service receives HUMS data from a multitude of operators, compiles the HUMS data, and communicates fleet management data to each of the multiple of operators as compared to a fleet of that aircraft type. The fleet management service provides an executive level summary of each operator's aircraft, maintenance and supply chain performance, with analysis of this performance compared to the fleet of that aircraft type.

### BACKGROUND OF THE INVENTION

The present invention relates to aircraft fleet management and more particularly to an aircraft fleet management system which utilizes real-time aircraft Health and Usage Monitoring System (HUMS) data to maximize aircraft readiness.

Various fleet management services are available to increase aircraft availability and operator profitability. The air-worthiness of a vast number of aircraft and other vehicles is dependent upon many inter-dependent subsystems. Often, when any one of many critical components fails or requires repair, service is disrupted because the entire aircraft or several major systems must be removed from service. Service disruption results in delays, cancellations and significant cost for operators. Traditionally, service disruptions are prevented or reduced by large parts inventories and by premature replacement of systems, subsystems and component parts. These remedies may be sub-optimum because inventories consume capital, risk obsolescence, and because premature maintenance and component replacement under-utilizes assets.

Accordingly, it is desirable to provide a fleet management service which links to HUMS, maintenance, and supply network databases to provide an executive level summary of each operators aircraft, maintenance and supply chain performance.

### SUMMARY OF THE INVENTION

A fleet management system according to an exemplary aspect of the present invention receives HUMS data from a multitude of operators, compiles the HUMS data, and communicates fleet management data to each of the multiple of operators as compared to a fleet of that aircraft type. Each operator is thereby provided with insight into each of the operator's aircraft performance as compared to the entire aircraft fleet. Through fleet wide data analysis of maintenance and operational data, emerging trends are identified and proactive corrective actions taken to maximize aircraft availability, drives down aircraft ownership costs and increase aircraft availability.

The present invention in certain exemplary environments therefore provides a fleet management service which links to HUMS, maintenance, and supply network databases to provide an executive level summary of each operators aircraft, maintenance and supply chain performance, with analysis of this performance.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1A is a schematic view of a fleet management service according to the present invention;

FIG. 1B is a schematic diagram which illustrates that a HUMS gathers data from various aircraft avionic subsystems as well as sensors located through out the rotorcraft;

FIG. 1C is a schematic view of a HUMS Service according to the present invention;

FIG. 2 is a block diagram illustrating a web portal webpage hierarchy of the fleet management system;

FIG. 3A is a fleet management system welcome web portal page;

FIG. 3B is a web portal page operational usage chart;

FIG. 3C is a web portal page illustrating operational usage in a chart format;

FIG. 3D is a web portal page of analyst comments regarding operational usage;

FIG. 4A is a web portal page directed to the HUMS Monitoring selection active;

FIG. 4B is a web portal page showing HUMS news;

FIG. 4C is a web portal page which provides HUMS exceedance parameter definitions;

FIG. 4D is another HUMS monitoring page illustrating operator rotor track and balance acquisition rates for a current month;

FIG. 4E is another HUMS monitoring page illustrating an operator's mechanical data acquisition rate for the current month;

FIG. 4F is another HUMS monitoring page illustrating operators monthly flight survey verse a fleet flight survey usage percentage;

FIG. 4G is another HUMS monitoring page illustrating HUMS drive train sensor location;

FIG. 4H is another HUMS monitoring page illustrating a component condition diagram;

FIG. 5A is a web portal page directed to the Top Removals section;

FIG. 5B is a web portal page illustrating Operator Removals Normalized per 1,000 hours;

FIG. 5C is a web portal page illustrating Operator vs. Similar Fleet Removals normalized per 1,000 hours;

FIG. 5D is a web portal page illustrating similar fleet removals normalized by 1,000 hours;

FIG. 5E is a web portal page which provides Top Warranty Removal Comments;

FIG. 6A is a web portal page directed to the Material Fill Rate Score Card selection;

FIG. 6B is a web portal page illustrating material fill rate for the year;

FIG. 6C is a web portal page regarding fill rate commentary;

FIG. 6D is a web portal page illustrating how material was filled; and

FIG. 6E is a web portal page illustrating maintenance and notifications to facilitate maintenance notification and supply chain performance to minimize aircraft downtime.

### DETAILED DESCRIPTION OF THE PREFERRED EMBODIMENT

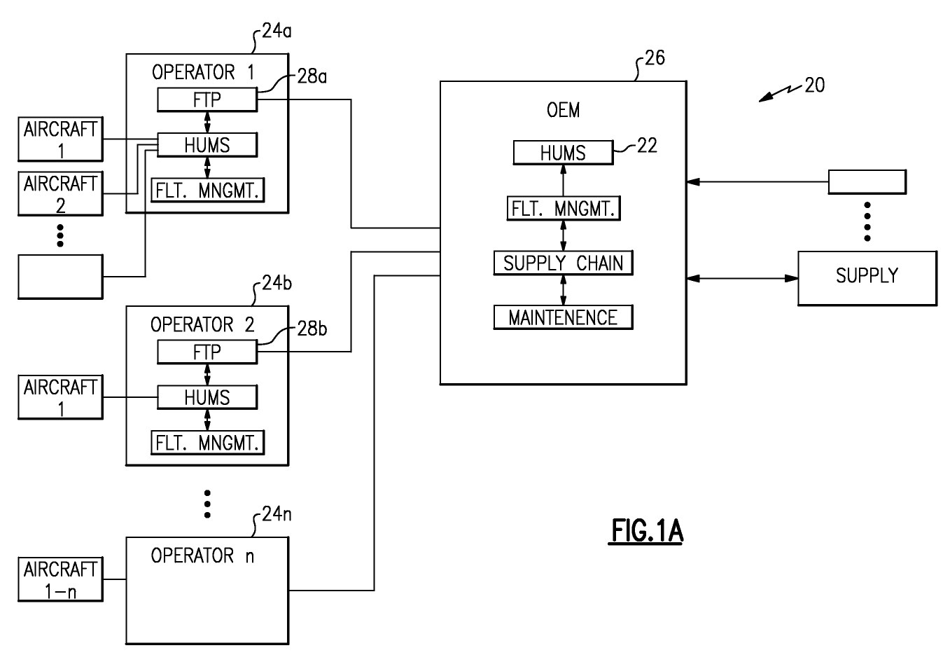

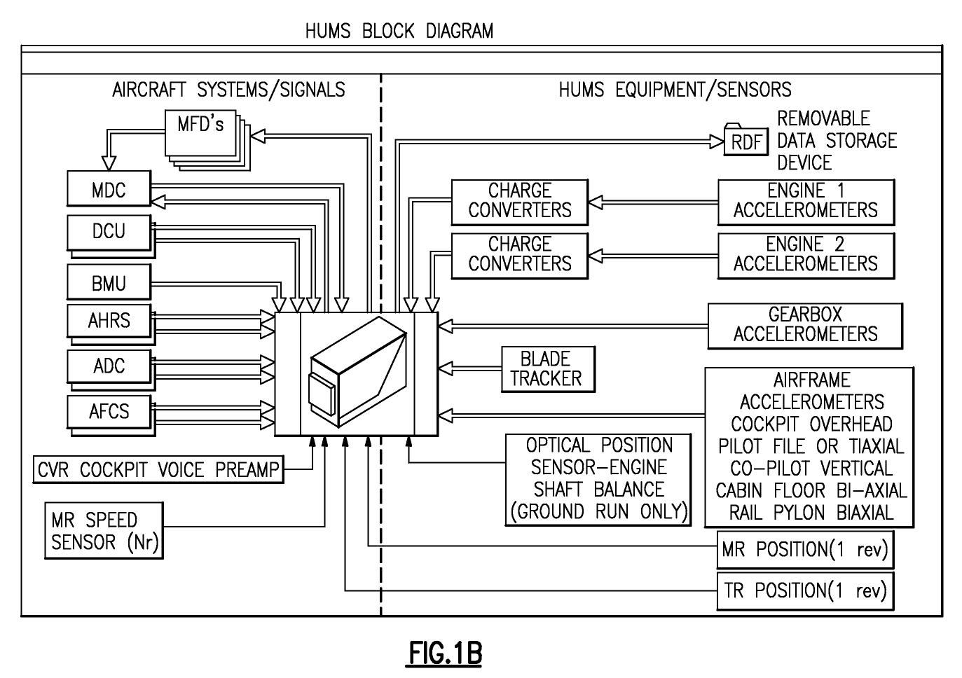

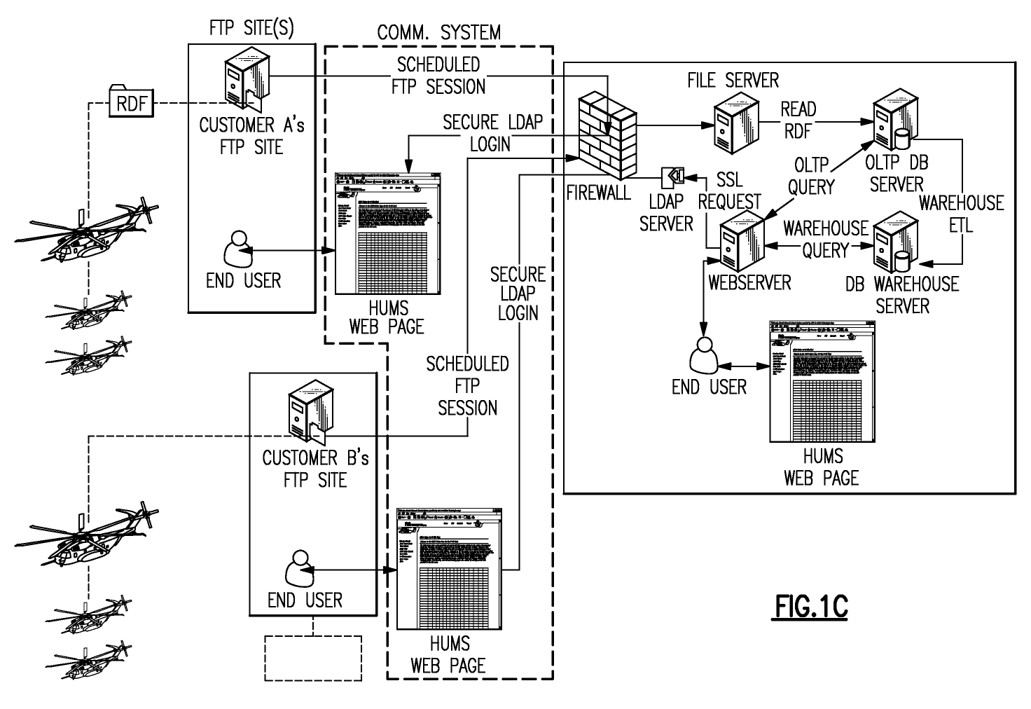

FIG. 1A schematically illustrates a fleet management service 20 in a block diagram format. The fleet management service 20 may be implemented through computer readable software in conjunction with a Health Usage and Monitoring System (HUMS) 22 (illustrated schematically in FIGS. 1B and 1C) which interconnects any number of operators 24a-24n with a higher level file server 26—such as would be typically based at an aircraft Original Equipment Manufacturer (OEM)—through a communication system such as a local area network server, an external network, such as the Internet, or an external storage device. It should be understood that various server systems will also be usable with the present invention and that the illustrated embodiment of an OEM base server systems are for descriptive purposed only.

Each operator 24a-24n collects HUMS data from each of a multitude of aircraft in, for example, an aircraft removable data storage device (FIG. 1B) which communicates with a multitude of aircraft sensors, avionic subsystems, and other HUMS data collection devices located on each aircraft as generally understood. HUMS data provides for examination of systems to provide detailed system analysis and go/no-go response for use by aircraft operations management. Various depths of HUMS data provide reactive and proactive detection and diagnosis of aircraft availability and airworthiness.

The HUMS data from each aircraft removable data storage device is uploaded through each operators FTP site 28a-28n (FIG. 1C). The FTP site 28a-28n connects each operator with the higher level file server 26 to collect and upload. The HUMS data from each operator to the file server 26. The fleet management service 20 utilizes information from the HUMS service 22 for maintenance management, operational records and fleet wide data analysis to provide detailed fleet management of each aircraft in each operator fleet for comparison to the entire aircraft fleet. The HUMS interconnects any number of users with the higher level file server through a communication system such as the internet or the like (FIG. 1C). It should be understood that various communication systems are usable with the present invention.

Each user may be a single aircraft operator or the operator of a fleet of aircraft in which each user initially collects HUMS data from each of a multitude of aircraft in an aircraft removable data storage device which communicates with a multitude of sensors, avionic subsystems, and other data collection device on each aircraft (illustrated schematically in FIG. 1B). The aircraft removable data storage device is removed from the aircraft and a HUMS Raw Data File (RDF) data therein is uploaded through each operator's FTP site.

The file server communicates with an on-line transactional database server (OLTP data base server) which is in communication with an associated warehouse server and webserver. The file server receives what may be differing HUMS data and converts the HUMS data to a common HUMS data format for storage in an OLTP database stored on the OLTP. That is, the various data formats utilized by each operator are processed into a common format. The HUMS may provide several ways (e.g. rule-based logic) to digest the analyzed data to create information that will be displayed at a top-level page. Rules may be created based on discrepancies or anomalies relative to fleet statistics or OEM based design assumptions (e.g. number of takeoffs does not equal landings or rate of change on a monitored parameter is greater than fleet average). Logic rules are applied to fact tables to produce higher-level information for notification of potential problems or issues (Alerts) during the transformation process from the OLTP database server to the OEM warehouse server. It should be understood that various tables may be usable and that different logic concepts (Such as neural network, fuzzy logic, etc) can be incorporated or utilized to produce higher level fleet information.

The uploaded HUMS data is then processed with, for example only, a series of SQL scripts which calculate statistics utilizing the uploaded data in the OLTP database server and then stores the raw HUMS data onto the warehouse. That is, the HUMS data file may be maintained within the OEM database server while the OLTP database server may store the calculated statistics therefrom in the OLTP database. Statistics may be calculated for each of a multitude of fact tables. The fact tables are related to the common features of HUMS data to accommodate data from different aircraft models as well as differing HUMS data. Such processing permits each operator to view the calculated statistics utilizing all aircraft from all operators to identify trend HUMS data across the entire aircraft fleet, yet assures that the RDF from aircraft owned by a particular user is only available to that particular user. Individual aircraft may thereby benefit from comparative information on HUMS parameters relative to fleet statistics such that the data may be acted upon to proactively support individual aircraft operations and maintenance. Each operator can view the data from a fleet prospective as well as drill down to a single HUMS acquisition on a particular flight for their own aircraft while the aircraft OEM has access to all information for the entire fleet.

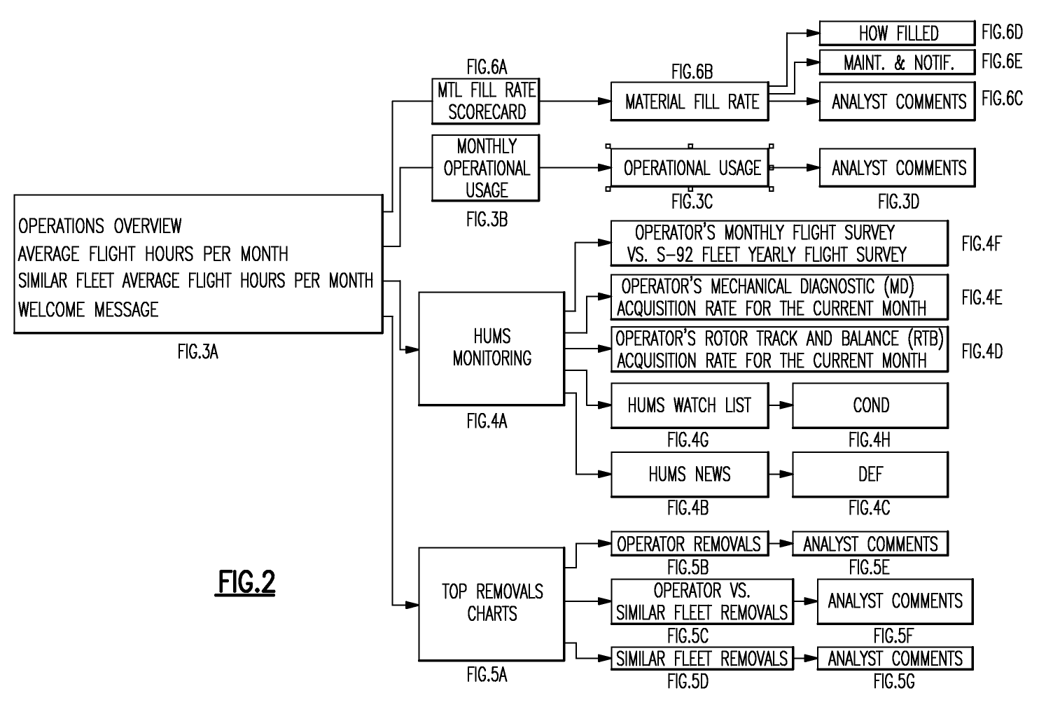

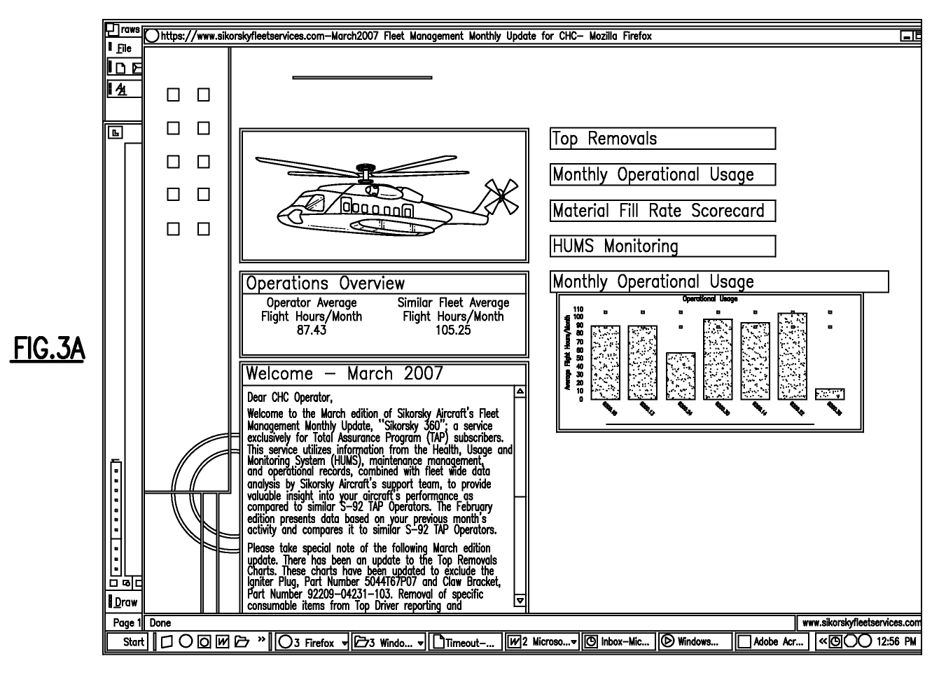

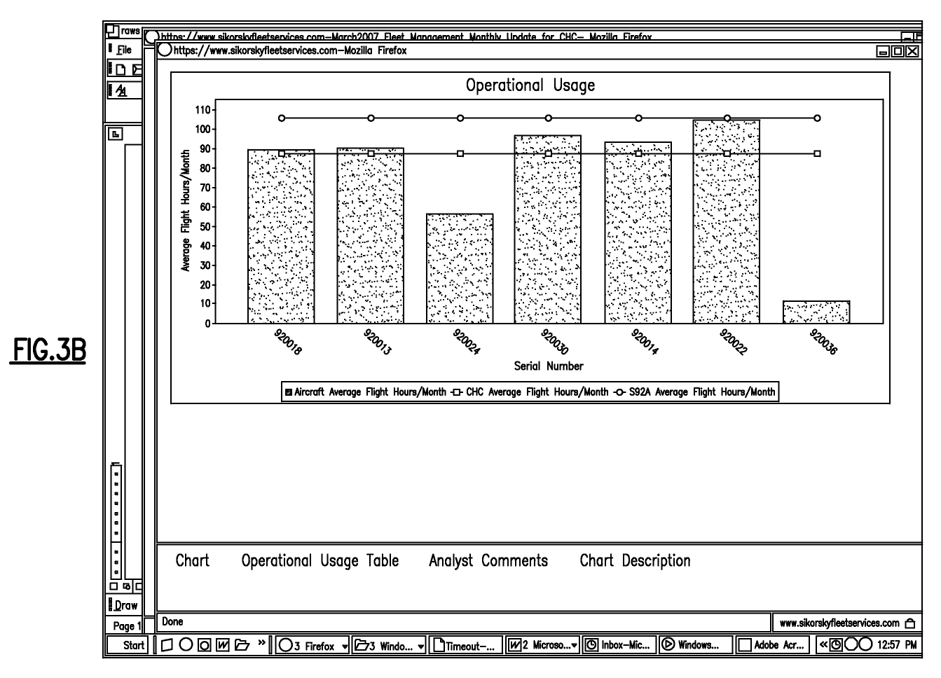

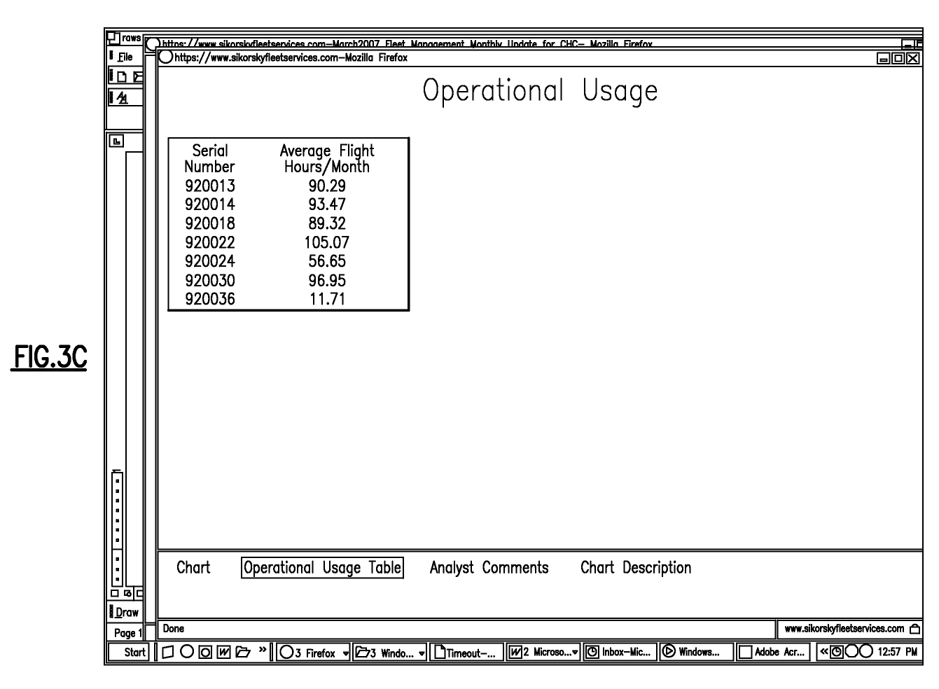

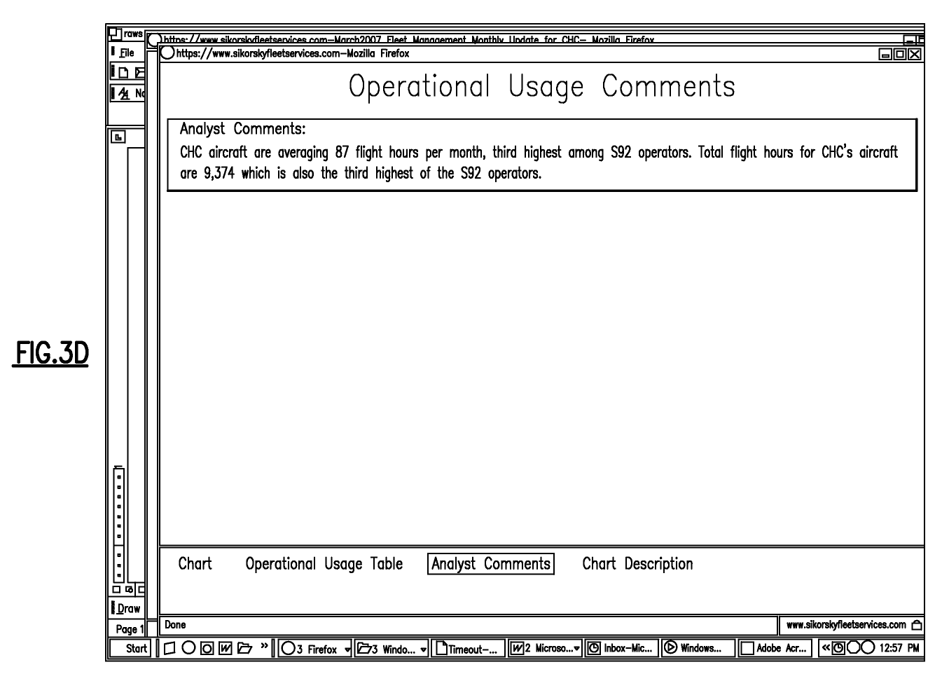

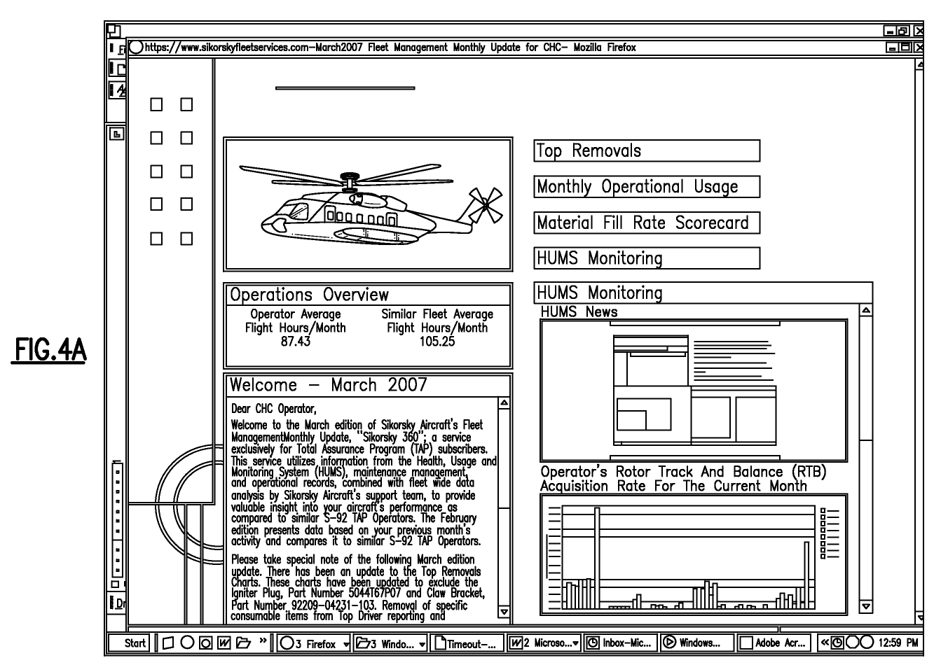

Referring to FIG. 2, a process flowchart illustrates the fleet management service 20 as a computer readable software system in which each block generally represents a page of an internet-based interface. The fleet management service 20 opens initially to a welcome page 30 (FIG. 3A) which generally displays an operations overview, a welcome message, and a multiple of selections which provide more detailed analysis here disclosed as TOP REMOVALS; MONTHLY OPERATIONAL USAGE; MATERIAL FILL RATE SCORE CARD; and HUMS MONITORING. Selection of any of these choices opens a more detailed series of information under that selection to provide various types of fleet management data. The opened chart may then be selected to obtain still further detailed analysis as will be further described below. It should be understood that any number of pages providing any desired fleet management data may additionally or alternatively be provided.

The monthly operational usage page 34 (FIG. 3B) generally depicts the average monthly usage of each aircraft in the operator's fleet. The horizontal lines illustrate the total fleet average and the operator's fleet average. The fleet average is compiled from flight profiles of similar operators. The operational usage may also be displayed in a table format (FIG. 3C) in which each of the operator's aircraft are referred to by serial number and the associated average flight hours per month. The operator is also provided with a reference to the operator's rank amongst all operators (FIG. 3D).

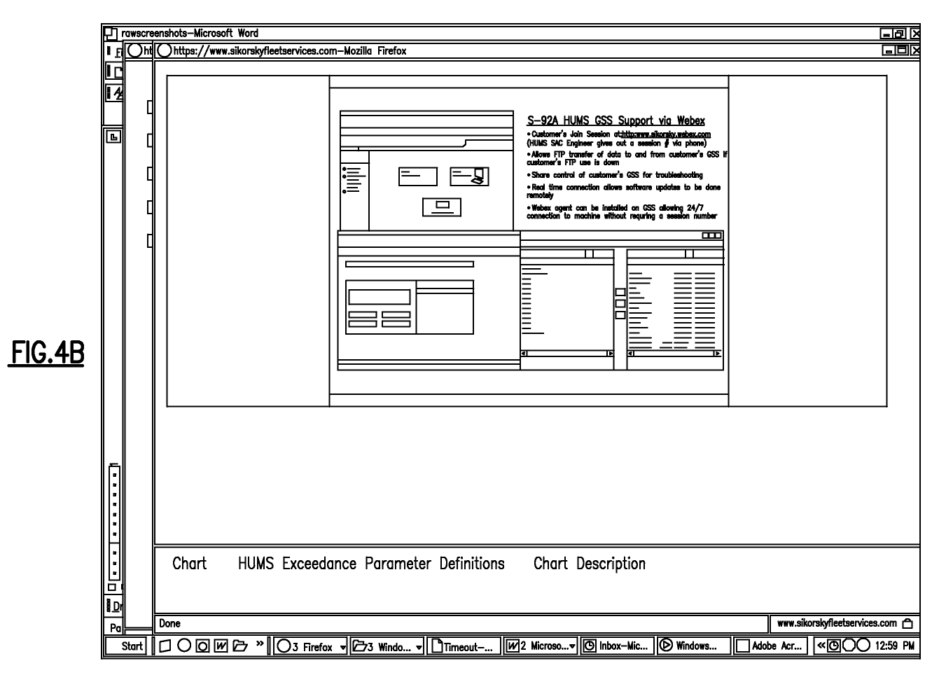

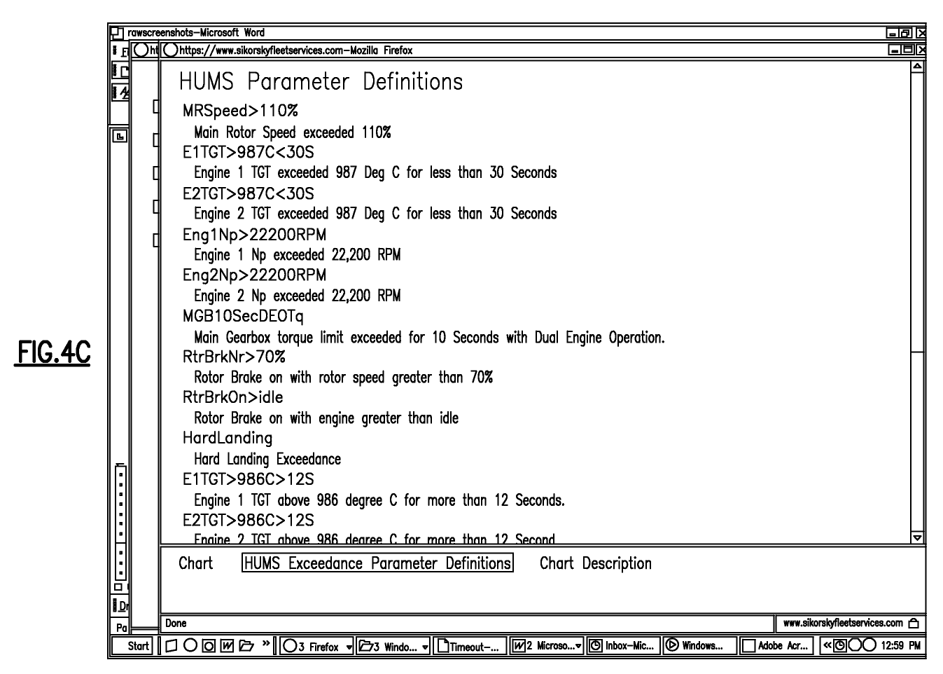

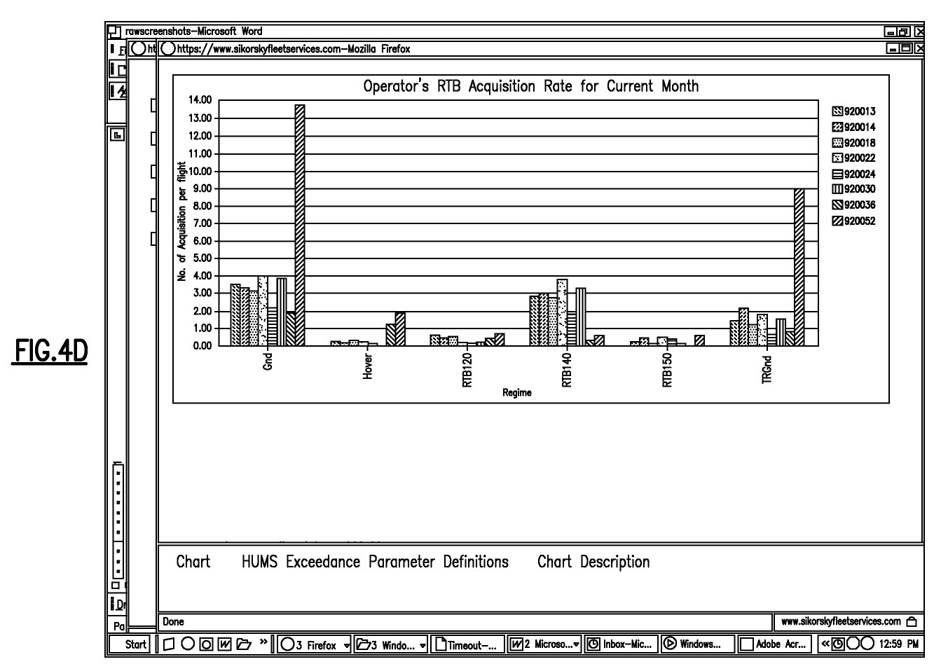

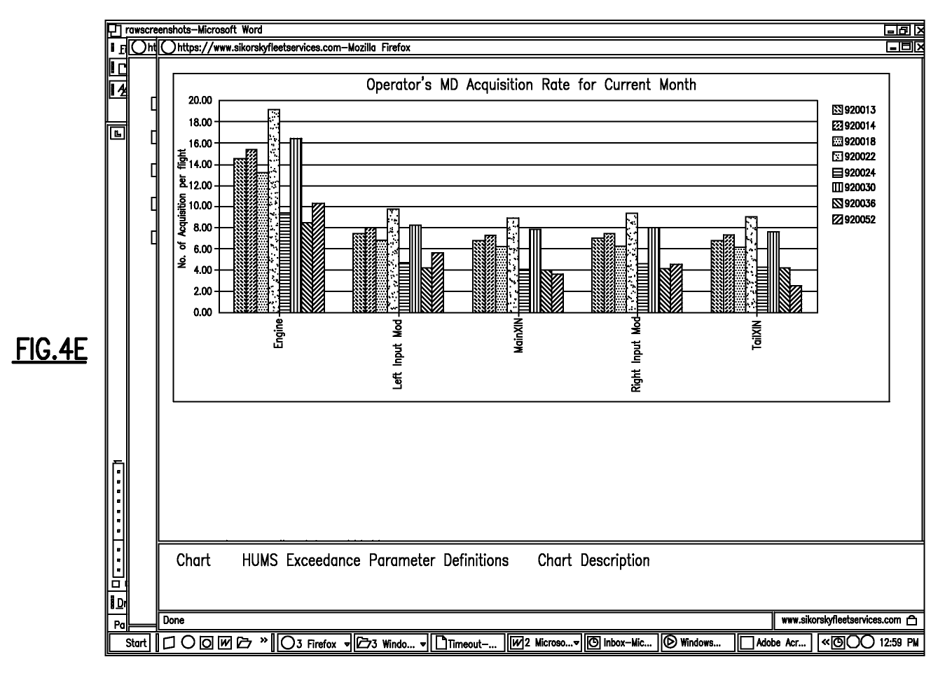

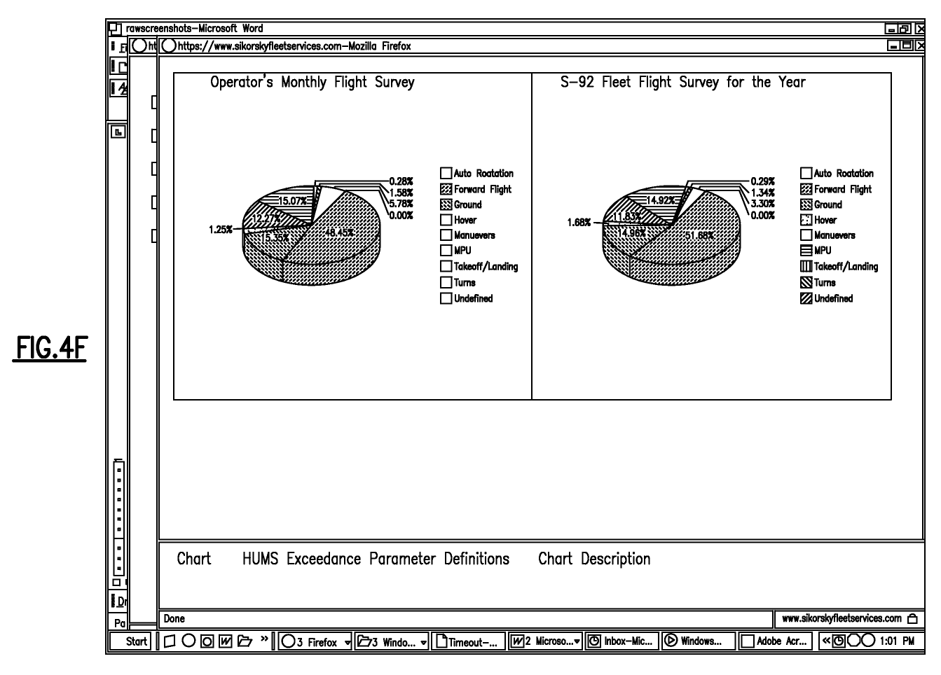

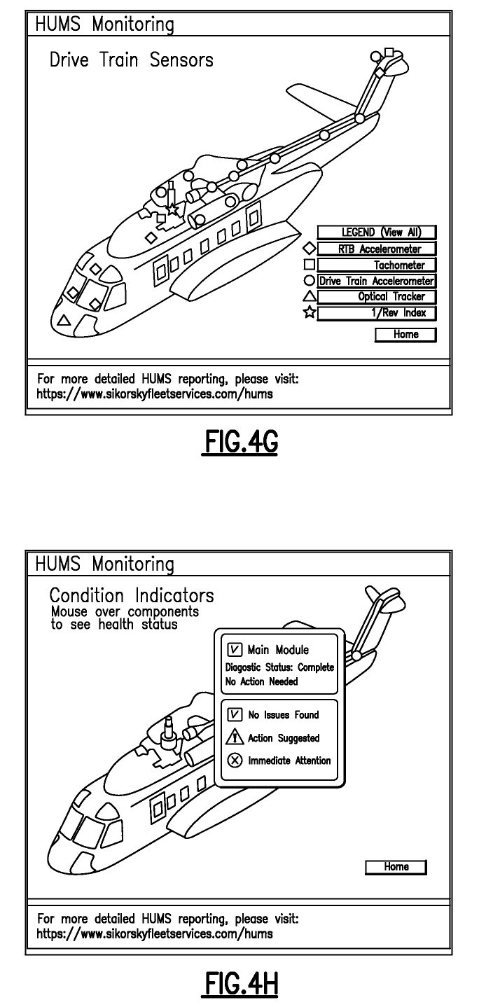

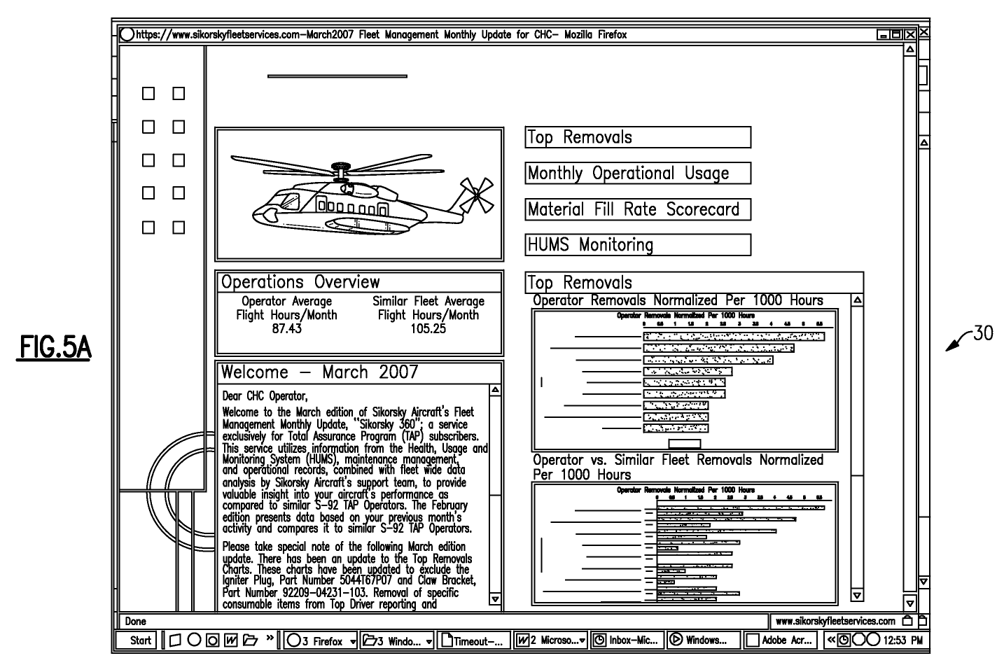

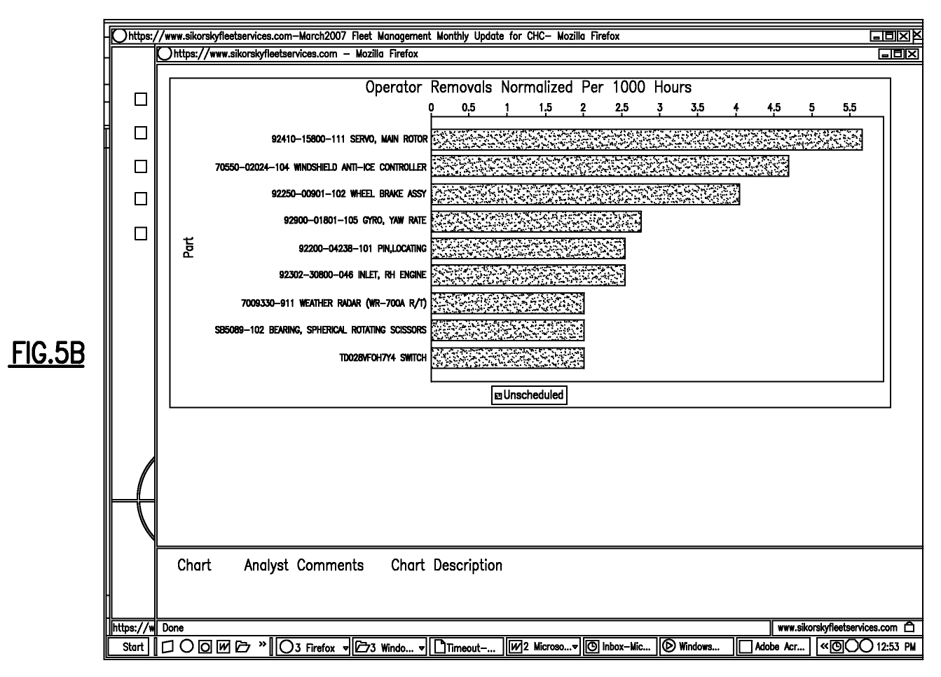

Selection of the HUMS monitoring option (FIG. 4A) opens a further multiple of HUMS related charts. The HUMS monitoring selection provides details to each operator regarding that operator's HUMS service. A HUMS news chart (FIG. 4B) highlights items that may be of interest to the operator and generally provides a snapshot of the current issues being addressed within the OEM HUMS engineering group. HUMS exceedance parameter definitions (FIG. 4C) as well as detailed HUMS sensor conditions for each operator of the aircraft (FIG. 4G) are also provided. The HUMS monitoring page 36 also includes the operator's RTB acquisition rate for the current month (FIG. 4D). The operator's RTB acquisition rate for current month chart illustrates the number of rotor track imbalance acquisition per aircraft for each flight regime for the current month to gauge reliability as an adequate number of acquisitions per flight is important for proper analysis. For example, hover may not provide as many acquisitions as ground and forward flight regimes because the aircraft does not stay in hover for a prolonged time period.

The HUMS monitoring page also includes an operator's mechanical diagnostic (MD) acquisition rate for the current month (FIG. 4E). As with the operator's rotor track imbalance (RTB) acquisition rate for the current month, the operator's MD acquisition rate for the current month chart illustrates the number of mechanical diagnostic acquisitions for the current month to gauge analysis reliability.

The HUMS monitoring page 36 also includes an operator's monthly flight survey and aircraft specific fleet flight survey for the year chart (FIG. 4F). The aircraft specific fleet flight survey for the year chart displays operational usage for the operator's fleet compared to the entire fleet of the specific aircraft. This chart illustrates the percentage of flight hours each operator spent flying in a regime for the month and each regime recognized by the HUMS. For comparison against the aircraft fleet, the chart presents the same data for all operators over all time. As illustrated in the disclosed example, this particular operator spends only 48.45% of flight time in forward flight which is less than the 51.68% average over the entire aircraft fleet.

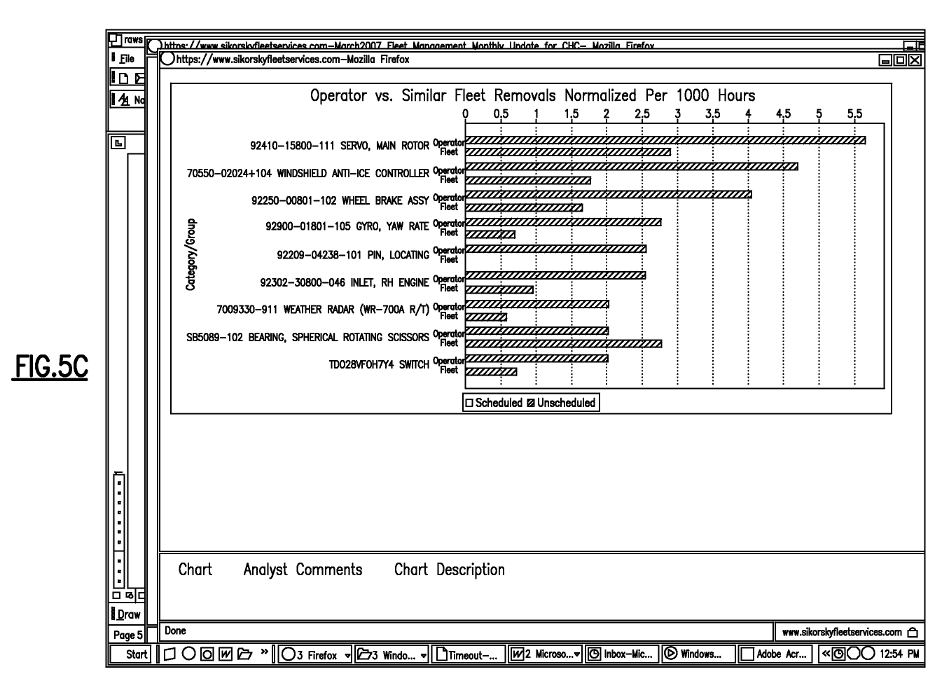

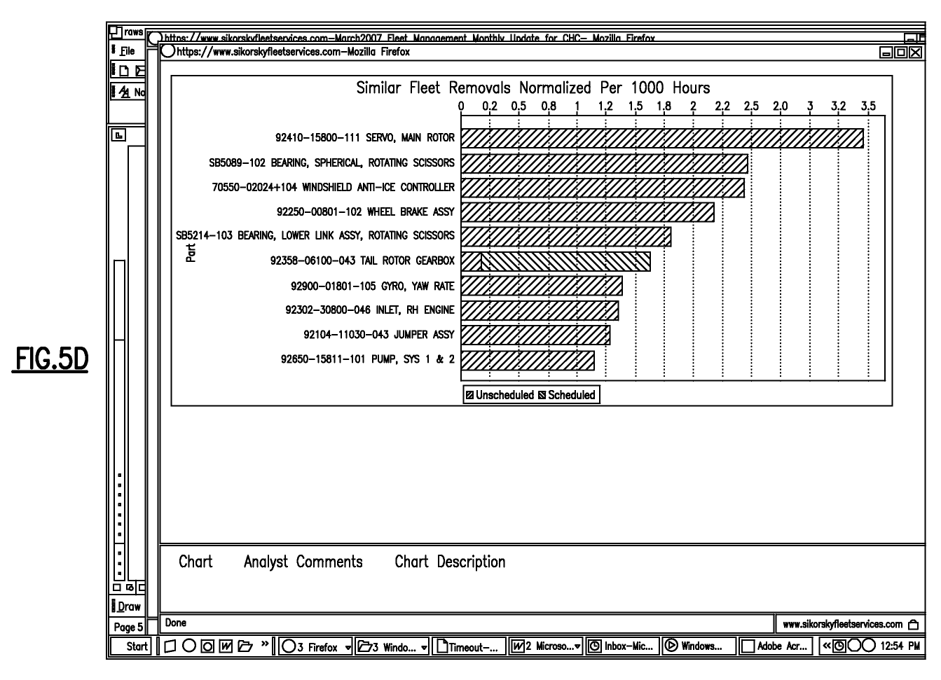

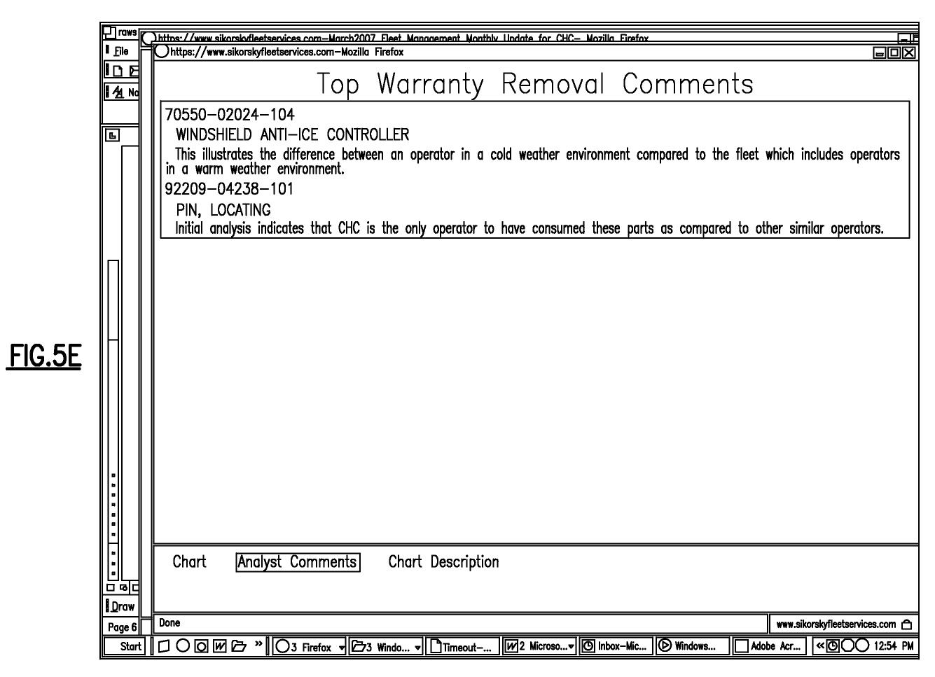

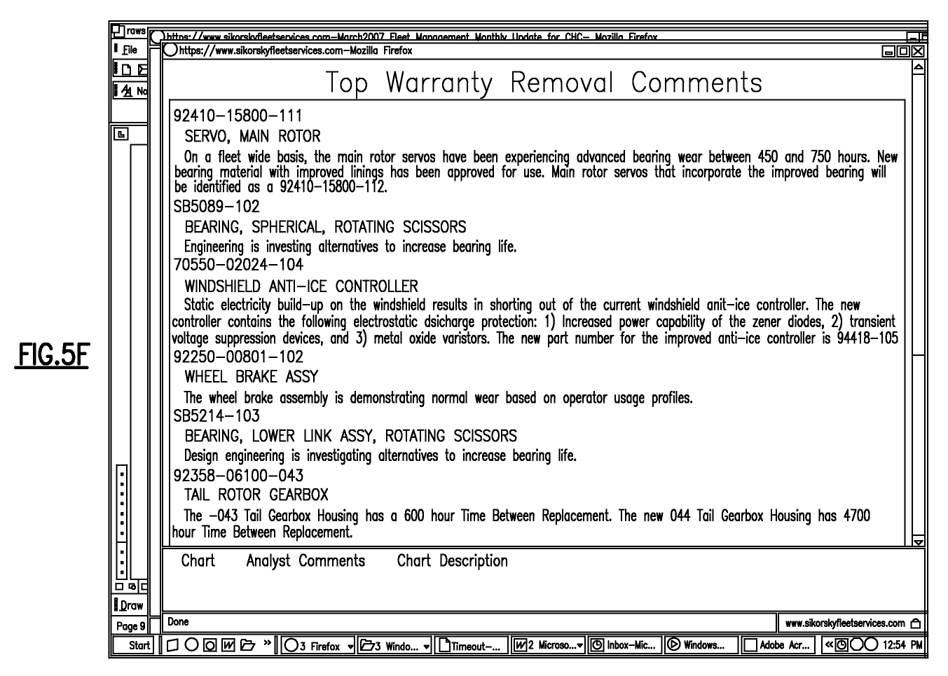

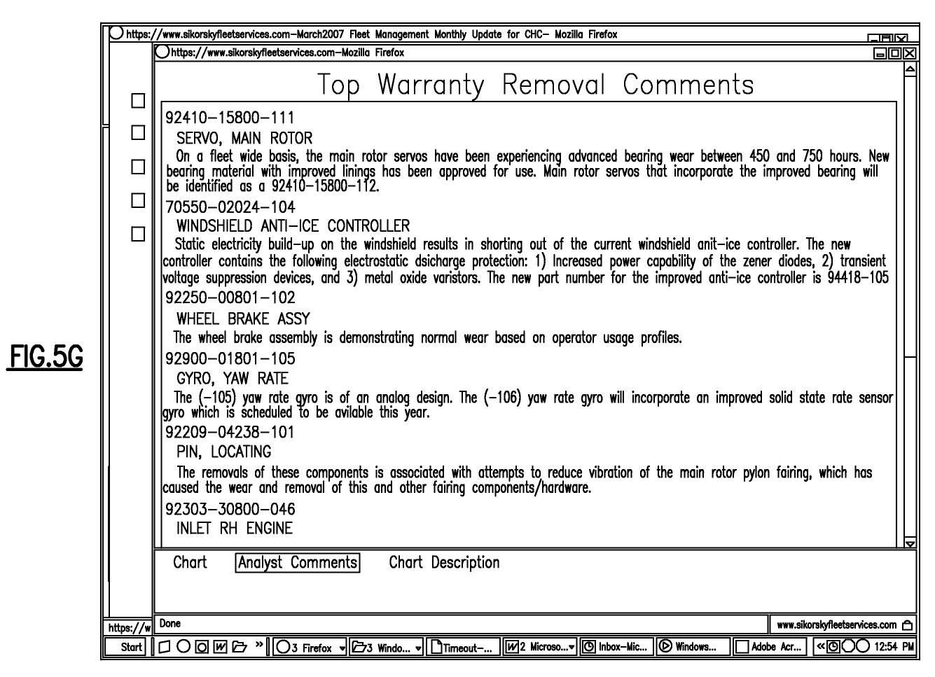

The top removals page 38 (FIG. 5A) generally provides operator removals normalized per 1,000 hours (FIG. 5B); operators vs. similar fleet removals normalized per 1,000 hours (FIG. 5C); and similar fleet removals normalized per 1,000 hours (FIG. 5D).

The operator removals normalized per 1,000 hours illustrates scheduled and unscheduled removals by that operator based on data submitted on “return to OEM aircraft” or the like type forms. These quantities are then normalized per 1,000 hours of similar type operators. These values represent the number of scheduled and unscheduled removals expressed in a uniform format in regard to quantity for a constant time period. Detailed comments are also available from this page (FIG. 5E).

The operator vs. similar fleet removals normalized per 1,000 hours chart compares the operator's top removals versus the same parts removed for the fleet. Comments are also delineated with regard to top warranty removal components (FIG. 14).

The similar fleet removal normalized per 1000 hrs (FIG. 5D) provides information with regard to the entire fleet such that each operator receives information which suggests what components are being replaced on a fleet-wide basis. Such fleet-wide understanding minimizes lead time expectation such that each operator may assure an adequate number of maintenance components are either on hand or on consignment to minimize aircraft downtime.

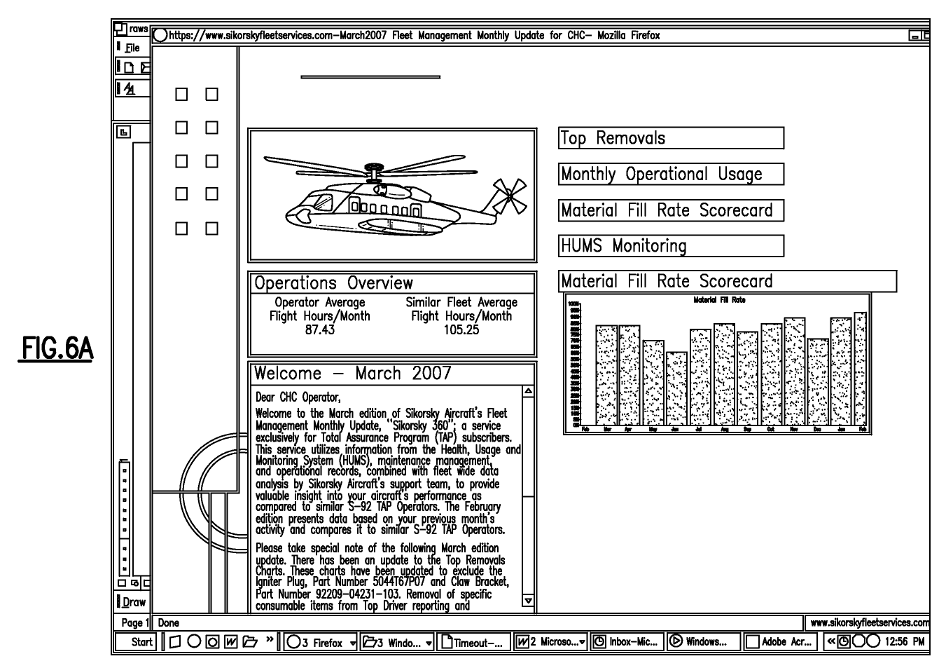

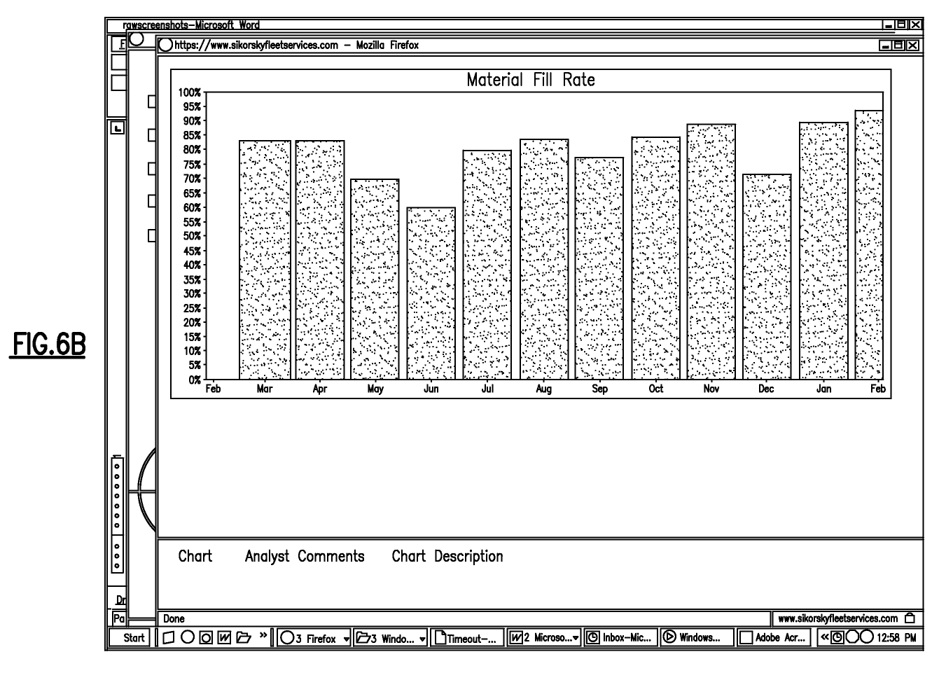

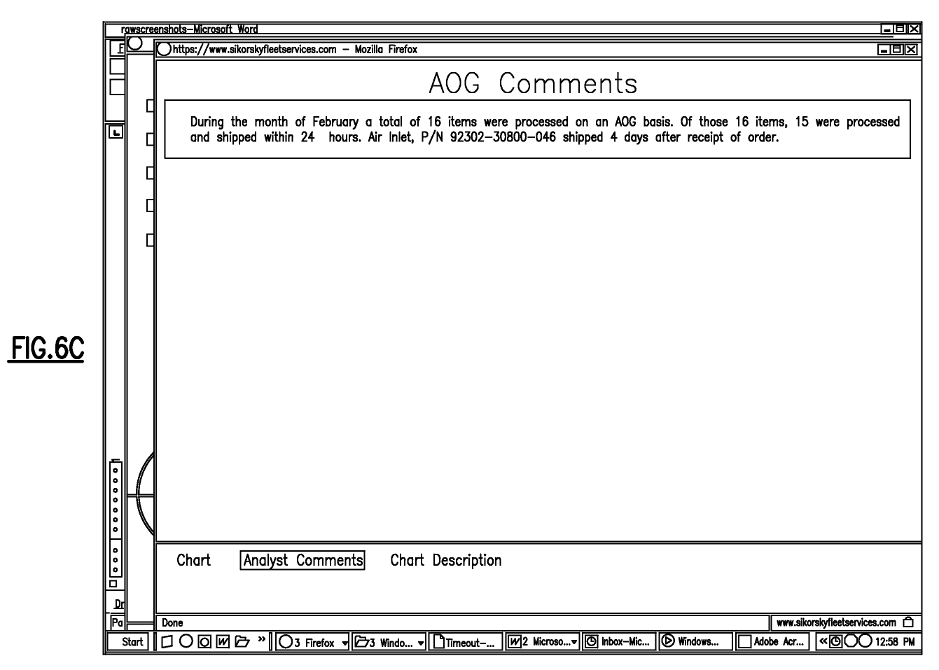

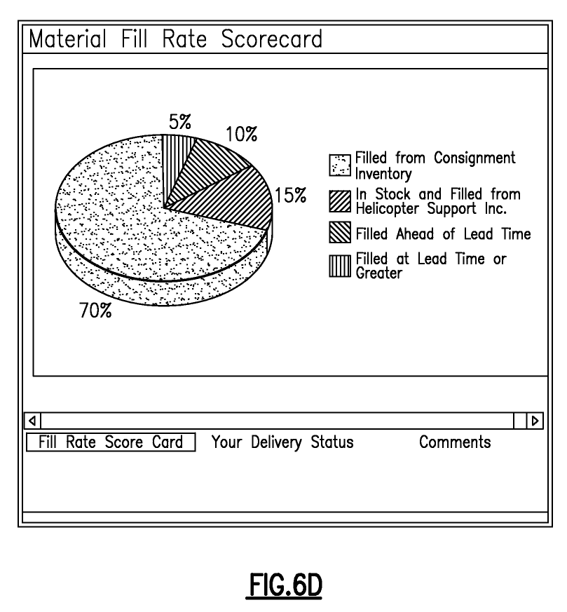

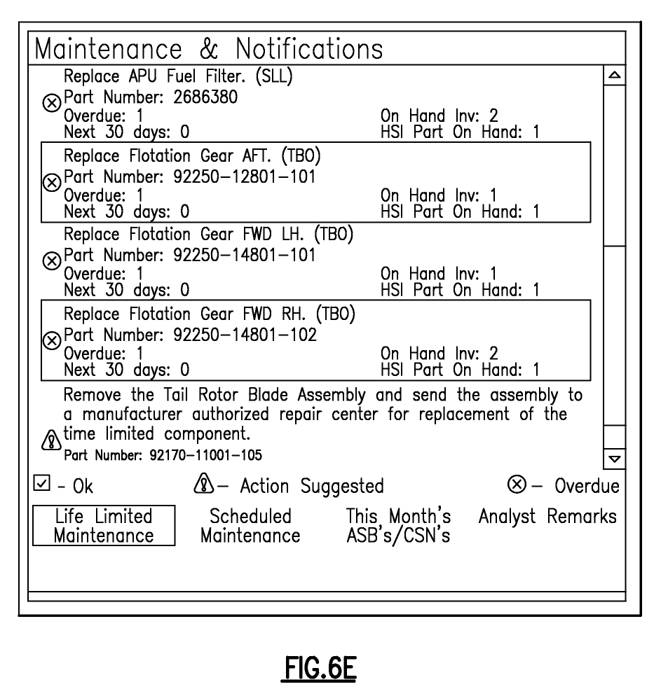

The material fill rate scorecard page 32 (FIG. 6A) provides a material fill rate chart (FIG. 6B) which depicts the percentage of material provided within a 24 hour period over the last twelve months. The AOG comments chart (FIG. 6C) provides a detailed availability notification such that component shipping delays are readily knowable by an operator and therefore readily planned for in advance to again further minimize aircraft downtime.

The material fill rate scorecard (FIG. 6D) provides further detailed analysis regarding how the component is available to the operator such as being: filled from consignment inventory; in stock and filled from helicopter support; filled ahead of lead time; and filled at lead time or greater. Interaction with the supply train in such an integrated manner streamlines component availability based on predictions associated with the aircraft operator's particular operations. The aircraft OEM and component supplier are also provided with information which facilitates prediction of expected component replacement and availability requirements to minimize aircraft downtime. The OEM HUMS engineering group is also provided with real time component part replacement rate information to provide information with potential component part continual improvement or redesign expectation.

Additional or alternative information may be provided including detailed description of expected maintenance and notifications therefor as delineated in a maintenance and notification page (FIG. 6E). The maintenance and notifications page may, for example, provide a list of suggested actions, the particular part required, and when the particular component should be ordered. Furthermore, this page may be utilized to place expected components on consignment to still further minimize or eliminate aircraft downtime by assurance that component ordering or inventories will affect scheduled maintenance events.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A computer-implemented method comprising:
receiving aircraft data from a multitude of operators which together operate a fleet of an aircraft type;
compiling the aircraft data from the multitude of operators; and
communicating the compiled aircraft data as fleet management data for each of the multiple of operators as compared to the fleet.

2. The method as recited in claim 1, wherein said communicating further comprises:
accessing HUMS data as a portion of the aircraft data; and
limiting access to HUMS data for an individual aircraft to only that operator which operates that individual aircraft.

3. The method as recited in claim 1, wherein said compiling further comprises:
converting differing aircraft data from each of the multitude of operators into a common data format.

4. The method as recited in claim 1, wherein said communicating further comprises:
communicating maintenance data as a portion of the fleet management data.

5. The method as recited in claim 4, wherein said communicating further comprises:
communicating supply chain data related to the maintenance data as a portion of the fleet management data.

6. The method as recited in claim 1, wherein said communicating further comprises:
communicating top removal data as a portion of the fleet management data.

7. The method as recited in claim 1, wherein said communicating further comprises:
communicating monthly operation usages as a portion of the fleet management data.

8. The method as recited in claim 1, wherein said communicating further comprises:
communicating material fill rata data as a portion of the fleet management data.

9. The method as recited in claim 1, wherein said communicating further comprises:
communicating HUMS monitoring data as a portion of the fleet management data.

10. The method as recited in claim 1, wherein said communicating further comprises:
communicating fleet removals normalized per 1,000 hours as a portion of the fleet management data.

11. The method as recited in claim 1, wherein said communicating further comprises:
communicating operator vs. similar fleet removals normalized per 1,000 hour data for that operator.

12. The method as recited in claim 1, wherein said communicating further comprises:
communicating operator top removals versus the same part removed for the fleet of that aircraft type for that operator.

13. The method as recited in claim 1, wherein said communicating further comprises:
communicating maintenance data as a list of suggested actions as a portion of the fleet management data.

14. The method as recited in claim 13, wherein said communicating further comprises:
communicating part availability data related to the list of suggested action as a portion of the fleet management data.

15. A computer-readable medium having stored thereon instructions for causing a computer to perform operations comprising:
receiving aircraft data from a multitude of operators which together operate a fleet of an aircraft type;
compiling the aircraft data from the multitude of operators; and
communicating the compiled aircraft data as fleet management data for each of the multiple of operators as compared to the fleet.

16. The medium as recited in claim 13, wherein said receiving and said communicating step are performed through an FTP server.

17. The medium as recited in claim 13, wherein said receiving and said communicating step are performed through an Internet-based system.

18. The method as recited in claim 1, wherein said communicating further comprises:
communicating a suggested maintenance action as a portion of the fleet management data;
communicating a particular part required as a portion of the fleet management data; and
communicating when said particular component should be ordered as a portion of the fleet management data.
